(19) United States
(12) Patent Application Publication
(10) Pub. No.: US 2026/0167854 A1
(43) Pub. Date: Jun. 18, 2026

(54) SILK-BASED ADHESIVE PLATFORM FOR FOOTWEAR AND FASHION

(71) Applicant: Trustees of Tufts College, Medford, MA (US)

(72) Inventors: Fiorenzo G. Omenetto, Lexington, MA (US); Marco Lo Presti, Arlington, MA (US)

(21) Appl. No.: 19/368,570

(22) Filed: Oct. 24, 2025

Related U.S. Application Data
(63) Continuation of application No. PCT/US24/26791, filed on Apr. 29, 2024.
(60) Provisional application No. 63/498,689, filed on Apr. 27, 2023.

(51) Int. Cl. C09J 189/00; A43D 25/20; C08J 5/12; C08K 3/16; C09J 5/00; C09J 11/04

(52) U.S. Cl. CPC C09J 189/00; A43D 25/20; C08J 5/127; C09J 5/00; C09J 11/04; C08J 2375/04; C08J 2489/00; C08K 2003/162; C08K 2003/166; C09J 2400/20; C09J 2475/008; C09J 2489/00

(57) ABSTRACT

Silk-based adhesives are made by dehydrating a silk fibroin solution including a chaotropic salt concentration, the adhesive including a non-water mixture and residual moisture, the non-water mixture including the silk fibroin and the chaotropic salt, the dehydrating inhibiting transitions to beta sheet secondary structure and providing one or more of the following properties: i) a predetermined viscosity or ii) a predetermined adhesive strength.

### CLAIM TO PRIORITY

This application claims benefit of and is a continuation of International Patent Application No. PCT/US2024/026791 (Attorney Docket No. 2095.0604), filed Apr. 29, 2024, and entitled “SILK-BASED ADHESIVE PLATFORM FOR FOOTWEAR AND FASHION,” International Pub. No. WO 2024/227146, which is hereby incorporated by reference in its entirety for all purposes.

International Patent Application No. PCT/US2024/026791 relates to, incorporates by reference for all purposes, and claims priority to U.S. Application Ser. No. 63/498,689 (Attorney Docket No. 2095.0537), filed Apr. 27, 2023.

### STATEMENT REGARDING FEDERALLY FUNDED RESEARCH

Not applicable.

### SEQUENCE LISTING

Not applicable.

### BACKGROUND

The fashion and footwear industries are respectively responsible for 6.7 and 1.4% of total CO₂ emissions. Considering footwear specifically, currently, 17 billion pairs of shoes are produced worldwide every year, and this figure continues to rise. This creates an enormous amount of post-consumer (end-of-life) shoe waste that is currently being disposed of in landfill sites around the world. The materials from which shoes are made are often synthetic and non-biodegradable and the adhesives that hold them together (which make up to 7% of a shoe) make it difficult to recycle/recover. Although there are alternative solvent-free adhesives, these are often water-based polyurethane solutions, which, while reducing the pollution related to the use of solvents, still present problems relating to the end life of the product. What is needed are more sustainable, biodegradable components that can be used in the fashion and footwear industries.

### SUMMARY

In some aspects, the techniques described herein relate to a shoe manufacturing method including adhering a low-energy surface of a first shoe part to a second surface of a second shoe part, wherein the low-energy surface has a surface energy less than 100 mJ/m2, the shoe manufacturing method including: a) adding a predetermined rehydration amount of water to a solid shoe manufacturing adhesive at a predetermined rehydration temperature to produce a rehydrated adhesive, optionally in less than 5 minutes, less than 4 minutes, less than 3 minutes, less than 2 minutes, or less than 1 minute, the solid shoe manufacturing adhesive including a non-water mixture and residual moisture, the non-water mixture including silk fibroin and a chaotropic salt, wherein the chaotropic salt is present in an amount by weight of the non-water mixture of between 5% and 95%, wherein the silk fibroin is present in an amount by weight of the non-water mixture of between 5% and 95%, wherein the chaotropic salt and the silk fibroin are present in the non-water mixture in a weight ratio of chaotropic salt to silk fibroin of between 20:1 and 1:15; and b) contacting opposing faces of a thin film of the rehydrated adhesive with the low-energy surface and the second surface under pressure and optionally at elevated temperature to adhere the low-energy surface to the second surface.

In some aspects, the techniques described herein relate to a textile manufacturing method including adhering a low-energy surface of a first textile to a second surface of the first textile or a second textile, wherein the low-energy surface has a surface energy less than 100 mJ/m2, the textile manufacturing method including: a) adding a predetermined rehydration amount of water to a solid shoe manufacturing adhesive at a predetermined rehydration temperature to produce a rehydrated adhesive, optionally in less than 5 minutes, less than 4 minutes, less than 3 minutes, less than 2 minutes, or less than 1 minute, the solid shoe manufacturing adhesive including a non-water mixture and residual moisture, the non-water mixture including silk fibroin and a chaotropic salt, wherein the chaotropic salt is present in an amount by weight of the non-water mixture of between 5% and 95%, wherein the silk fibroin is present in an amount by weight of the non-water mixture of between 5% and 95%, wherein the chaotropic salt and the silk fibroin are present in the non-water mixture in a weight ratio of chaotropic salt to silk fibroin of between 20:1 and 1:15; and b) contacting opposing faces of a thin film of the rehydrated adhesive with the low-energy surface and the second surface under pressure and optionally at elevated temperature to adhere the low-energy surface to the second surface.

In some aspects, the techniques described herein relate to a manufacturing method including adhering a low-energy surface to a second surface, wherein the low-energy surface has a surface energy less than 100 mJ/m2, the manufacturing method including: a) adding a predetermined rehydration amount of water to a solid manufacturing adhesive at a predetermined rehydration temperature to produce a rehydrated adhesive, optionally in less than 5 minutes, less than 4 minutes, less than 3 minutes, less than 2 minutes, or less than 1 minute, the solid manufacturing adhesive including a non-water mixture and residual moisture, the non-water mixture including silk fibroin and a chaotropic salt, wherein the chaotropic salt is present in an amount by weight of the non-water mixture of between 5% and 95%, wherein the silk fibroin is present in an amount by weight of the non-water mixture of between 5% and 95%, wherein the chaotropic salt and the silk fibroin are present in the non-water mixture in a weight ratio of chaotropic salt to silk fibroin of between 20:1 and 1:15; and b) contacting opposing faces of a thin film of the rehydrated adhesive with the low-energy surface and the second surface under pressure and optionally at elevated temperature to adhere the low-energy surface to the second surface.

In some aspects, the techniques described herein relate to a solid shoe manufacturing adhesive including a non-water mixture and residual moisture, the non-water mixture including silk fibroin and a chaotropic salt, wherein: the silk fibroin is present in the non-water mixture in an amount by weight of between 5% and 95% and the chaotropic salt is present in the non-water mixture in an amount by weight of between 5% and 95% of the non-water mixture; and the chaotropic salt and the silk fibroin are present in a weight ratio of chaotropic salt to silk fibroin of between 15:1 and 1:20.

In some aspects, the techniques described herein relate to a solid textile manufacturing adhesive including a non-water mixture and residual moisture, the non-water mixture including silk fibroin and a chaotropic salt, wherein: the silk fibroin is present in the non-water mixture in an amount by weight of between 5% and 95% and the chaotropic salt is present in the non-water mixture in an amount by weight of between 5% and 95% of the non-water mixture; and the chaotropic salt and the silk fibroin are present in a weight ratio of chaotropic salt to silk fibroin of between 15:1 and 1:20.

In some aspects, the techniques described herein relate to a solid manufacturing adhesive including a non-water mixture and residual moisture, the non-water mixture including silk fibroin and a chaotropic salt, wherein: the silk fibroin is present in the non-water mixture in an amount by weight of between 5% and 95% and the chaotropic salt is present in the non-water mixture in an amount by weight of between 5% and 95% of the non-water mixture; and the chaotropic salt and the silk fibroin are present in a weight ratio of chaotropic salt to silk fibroin of between 15:1 and 1:20.

In some aspects, the techniques described herein relate to a solid shoe manufacturing adhesive made by dehydrating a silk fibroin solution including a chaotropic salt concentration of between 5 mg/mL and 100 mg/mL, the solid shoe manufacturing adhesive including a non-water mixture and residual moisture, the non-water mixture including the silk fibroin and the chaotropic salt, the dehydrating inhibiting transitions to beta sheet secondary structure and providing one or more of the following properties: i) a predetermined viscosity of between 100 cps and 500,000 cps upon addition of a predetermined viscosity amount of water at a predetermined viscosity temperature; or ii) a predetermined adhesive strength of at least 0.1 N/mm between two predetermined surfaces upon addition of a predetermined adhesive strength amount of water at a predetermined adhesive strength temperature and subsequent contact with the two predetermined surfaces under pressure, wherein the solid shoe manufacturing adhesive is rehydrated in less than 5 minutes, less than 4 minutes, less than 3 minutes, less than 2 minutes, or less than 1 minute under rehydrating conditions.

In some aspects, the techniques described herein relate to a solid textile manufacturing adhesive made by dehydrating a silk fibroin solution including a chaotropic salt concentration of between 5 mg/mL and 100 mg/mL, the solid textile manufacturing adhesive including a non-water mixture and residual moisture, the non-water mixture including the silk fibroin and the chaotropic salt, the dehydrating inhibiting transitions to beta sheet secondary structure and providing one or more of the following properties: i) a predetermined viscosity of between 100 cps and 500,000 cps upon addition of a predetermined viscosity amount of water at a predetermined viscosity temperature; or ii) a predetermined adhesive strength of at least 0.1 N/mm between two predetermined surfaces upon addition of a predetermined adhesive strength amount of water at a predetermined adhesive strength temperature and subsequent contact with the two predetermined surfaces under pressure, wherein the solid textile manufacturing adhesive is rehydrated in less than 5 minutes, less than 4 minutes, less than 3 minutes, less than 2 minutes, or less than 1 minute under rehydrating conditions.

In some aspects, the techniques described herein relate to a solid manufacturing adhesive made by dehydrating a silk fibroin solution having dissolved therein chaotropic salts in amounts of between 5 mg/mL and 100 mg/mL the solid manufacturing adhesive including a non-water mixture and residual moisture, the non-water mixture including the silk fibroin and the chaotropic salt, the dehydrating inhibiting transitions to beta sheet secondary structure and providing one or more of the following properties: i) a predetermined viscosity of between 100 cps and 500,000 cps upon addition of a predetermined viscosity amount of water at a predetermined viscosity temperature; or ii) a predetermined adhesive strength of at least 0.1 N/mm between two predetermined surfaces upon addition of a predetermined adhesive strength amount of water at a predetermined adhesive strength temperature and subsequent contact with the two predetermined surfaces under pressure, wherein the solid manufacturing adhesive is rehydrated in less than 5 minutes, less than 4 minutes, less than 3 minutes, less than 2 minutes, or less than 1 minute under rehydrating conditions.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1: (a) solid silk containing 50 mg/mL of CaCl₂; (b) dissolution of the solid through the addition of water and heating; (c) application of the adhesive trough brushing on tanned leather; (d) Mechanical T-Peel test of the adhesive between tanned leather and plant-based polyurethane.

FIG. 2: T-Peel test results of Silk-Mg adhesive spread on materials for footwear.

FIG. 3: T-Peel test results of Silk-Ca adhesive with different water content spread on materials for footwear.

### DETAILED DESCRIPTION

Before the present disclosure is described in further detail, it is to be understood that the disclosure is not limited to the particular embodiments described. It is also understood that the terminology used herein is for the purpose of describing particular embodiments only, and is not intended to be limiting. The scope of the present disclosure will be limited only by the claims. As used herein, the singular forms “a”, “an”, and “the” include plural embodiments unless the context clearly dictates otherwise.

In this application, unless otherwise clear from context, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; and (iv) the terms “about” and “approximately” are used as equivalents and may be understood to permit standard variation as would be understood by those of ordinary skill in the art; and (v) where ranges are provided, endpoints are included.

Approximately: as used herein, the term “approximately” or “about,” as applied to one or more values of interest, refers to a value that is similar to a stated reference value. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Composition: as used herein, may be used to refer to a discrete physical entity that comprises one or more specified components. In general, unless otherwise specified, a composition may be of any form—e.g., gas, gel, liquid, solid, etc. In some embodiments, “composition” may refer to a combination of two or more entities for use in a single embodiment or as part of the same article. It is not required in all embodiments that the combination of entities result in physical admixture, that is, combination as separate co-entities of each of the components of the composition is possible; however many practitioners in the field may find it advantageous to prepare a composition that is an admixture of two or more of the ingredients in a pharmaceutically acceptable carrier, diluent, or excipient, making it possible to administer the component ingredients of the combination at the same time.

Improve, increase, or reduce: as used herein or grammatical equivalents thereof, indicate values that are relative to a baseline measurement, such as a measurement in a similar composition made according to previously known methods.

Substantially: as used herein, the term “substantially” refers to the qualitative condition of exhibiting total or near-total extent or degree of a characteristic or property of interest. One of ordinary skill in the biological arts will understand that biological and chemical phenomena rarely, if ever, go to completion and/or proceed to completeness or achieve or avoid an absolute result. The term “substantially” is therefore used herein to capture the potential lack of completeness inherent in many biological and chemical phenomena.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

As used herein, “silk fibroin” refers to silk fibroin protein whether produced by silkworm, spider, or other insect, or otherwise generated (Lucas et al., Adv. Protein Chem., 13:107-242 (1958)). Any type of silk fibroin can be used in different embodiments described herein. Silk fibroin produced by silkworms, such as Bombyx mori, is the most common and represents an earth-friendly, renewable resource. For instance, silk fibroin used in a silk film may be attained by extracting sericin from the cocoons of B. mori. Organic silkworm cocoons are also commercially available. There are many different silks, however, including spider silk (e.g., obtained from Nephila clavipes), transgenic silks, genetically engineered silks, such as silks from bacteria, yeast, mammalian cells, transgenic animals, or transgenic plants, and variants thereof, that can be used. See, e.g., WO 97/08315 and U.S. Pat. No. 5,245,012, each of which is incorporated herein by reference in their entireties.

Disclosed herein is a silk-based adhesive platform. Exemplary silk-based adhesives are described in the context of the fashion and footwear industries throughout this specification, however, it should be understood that the silk-based adhesives disclosed herein may be used in any known or yet-to-be known adhesive application.

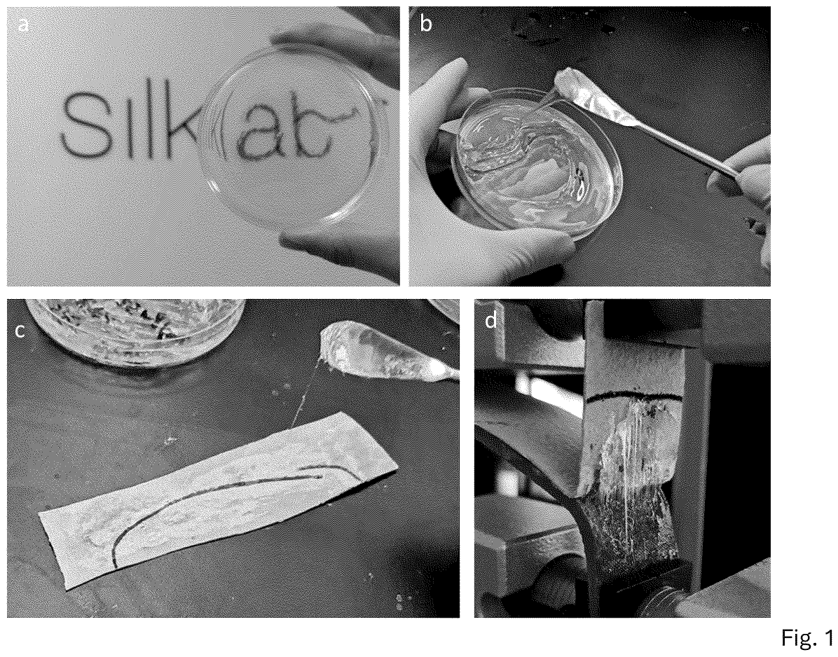

Also disclosed herein is a silk solution process that allows for the production of a solid adhesive (FIG. 1A) which can be rehydrated to the desired viscosity (FIG. 1B). This viscous solution can be spread on various types of substrates commonly used in fashion and footwear (FIG. 1C), such as chrome and vegetable tanned leathers, polyurethane (PU), thermoplastic polyurethane (TPU), thermoplastic rubber (TR), styrene-butadiene rubber (SBR), styrene-butadiene-styrene rubber (SBS), ethylene-vinyl acetate (EVA), polyamide (PA), poly(vinyl chloride) (PVC), polystyrene (PS) or acrylonitrile-butadiene-styrene (ABS)) where it displays adhesive properties.

Control of viscosity through rehydration enables flexibility in the choice of application procedures already employed for common adhesives, such as those used in the footwear industry (e.g., brush, gun, or roller). Silk-based adhesives have an advantage over conventional adhesives because in its solid form, it is not adhesive but becomes adhesive upon hydration. Viscosity control makes it possible to obtain adhesives with different rheologies and therefore compatible with different processes/substrates starting from a stable and shelf-stable solid. Furthermore, it is possible to modulate different properties of the adhesive by adding components to the solution before its drying (e.g., glycerol for flexibility, dopamine or other catechols for water resistance, or crosslinker for toughness). A further advantage of silk-based adhesive is an increased shelf life relative to conventional adhesives.

Disclosed herein is a shoe manufacturing method. The method includes adhering a low-energy surface of a first shoe part to a second surface of a second shoe part. The low-energy surface has a surface energy less than 100 mJ/m². The method includes adding a predetermined rehydration amount of water to a solid shoe manufacturing adhesive at a predetermined rehydration temperature to produce a rehydrated adhesive. The adding effectively activates the adhesive property of the adhesive.

Without wishing to be bound by any particular theory, it is believed that the adhesive disclosed herein can be rehydrated in an unexpectedly short length of time. Without wishing to be bound any particular theory, it was expected that rehydration of these sorts of compositions would take significantly longer. In some cases, rehydration can produce the adhesive properties in an unexpectedly short adding time. The rehydrated adhesive may be produced in less than 5 minutes upon adding a predetermined rehydration amount of water to the solid shoe manufacturing adhesive. The rehydrated adhesive may be produced in less than 4 minutes upon adding a predetermined rehydration amount of water to the solid shoe manufacturing adhesive. The rehydrated adhesive may be produced in less than 3 minutes upon adding a predetermined rehydration amount of water to the solid shoe manufacturing adhesive. The rehydrated adhesive may be produced in less than 2 minutes upon adding a predetermined rehydration amount of water to the solid shoe manufacturing adhesive. The rehydrated adhesive may be produced in less than 1 minute upon adding a predetermined rehydration amount of water to the solid shoe manufacturing adhesive.

In this particular aspect of the invention and throughout the other aspects, a feature of a length of time is disclosed in relation to adding to produce a rehydrated adhesive. This length of time is intended to be interpreted broadly to encompass adding through a variety of rehydration means, whether through rapid or slow addition of liquid. The length of time begins at the point of first water contact during rehydration. In some cases, all water is added and then heating and/or mixing following the water addition makes up the bulk of the length of time. In some cases, the water is added over the course of time, either the full length of time or a portion of it.

In embodiments, the solid shoe manufacturing adhesive includes a non-water mixture and residual moisture, the non-water mixture including silk fibroin and a chaotropic salt. In some examples, the chaotropic salt is present in an amount by weight of the non-water mixture of between 5% and 95%. In some examples, the silk fibroin is present in an amount by weight of the non-water mixture of between 5% and 95%. In some examples, the chaotropic salt and the silk fibroin are present in the non-water mixture in a weight ratio of chaotropic salt to silk fibroin of between 20:1 and 1:15. The shoe manufacturing method also includes contacting opposing faces of a thin film of the rehydrated adhesive with the low-energy surface and the second surface under pressure to adhere the low-energy surface to the second surface. Contacting may also be at elevated temperature.

Disclosed herein is a textile manufacturing method. The textile manufacturing method includes adhering a low-energy surface of a first textile to a second surface of the first textile or a second textile. The low-energy surface has a surface energy less than 100 mJ/m². The textile manufacturing method includes adding a predetermined rehydration amount of water to a textile manufacturing adhesive at a predetermined rehydration temperature to produce a rehydrated adhesive. The adding effectively activates the adhesive property of the adhesive.

In some cases, rehydration can produce the adhesive properties in an unexpectedly short adding time. The rehydrated adhesive may be produced in less than 5 minutes upon adding a predetermined rehydration amount of water to the textile manufacturing adhesive. The rehydrated adhesive may be produced in less than 4 minutes upon adding a predetermined rehydration amount of water to the textile manufacturing adhesive. The rehydrated adhesive may be produced in less than 3 minutes upon adding a predetermined rehydration amount of water to the textile manufacturing adhesive. The rehydrated adhesive may be produced in less than 2 minutes upon adding a predetermined rehydration amount of water to the textile manufacturing adhesive. The rehydrated adhesive may be produced in less than 1 minute upon adding a predetermined rehydration amount of water to the textile manufacturing adhesive.

The textile manufacturing adhesive includes a non-water mixture and residual moisture, the non-water mixture including silk fibroin and a chaotropic salt. In embodiments, the chaotropic salt is present in an amount by weight of the non-water mixture of between 5% and 95%. In examples, the silk fibroin is present in an amount by weight of the non-water mixture of between 5% and 95%. In examples, the chaotropic salt and the silk fibroin are present in the non-water mixture in a weight ratio of chaotropic salt to silk fibroin of between 20:1 and 1:15. The textile manufacturing method also includes contacting opposing faces of a thin film of the rehydrated adhesive with the low-energy surface and the second surface under pressure to adhere the low-energy surface to the second surface. Contacting may also be done at elevated temperature.

Disclosed herein is a manufacturing method including adhering a low-energy surface to a second surface, wherein the low-energy surface has a surface energy less than 100 mJ/m². The manufacturing method includes adding a predetermined rehydration amount of water to a solid manufacturing adhesive at a predetermined rehydration temperature to produce a rehydrated adhesive. The adding effectively activates the adhesive property of the adhesive.

In some cases, rehydration can produce the adhesive properties in an unexpectedly short adding time. The rehydrated adhesive may be produced in less than 5 minutes upon adding a predetermined rehydration amount of water to the solid manufacturing adhesive. The rehydrated adhesive may be produced in less than 4 minutes upon adding a predetermined rehydration amount of water to the solid manufacturing adhesive. The rehydrated adhesive may be produced in less than 3 minutes upon adding a predetermined rehydration amount of water to the solid manufacturing adhesive. The rehydrated adhesive may be produced in less than 2 minutes upon adding a predetermined rehydration amount of water to the solid manufacturing adhesive. The rehydrated adhesive may be produced in less than 1 minute upon adding a predetermined rehydration amount of water to the solid manufacturing adhesive. The solid manufacturing adhesive may include a non-water mixture and residual moisture. The non-water mixture includes silk fibroin and a chaotropic salt. In examples, the chaotropic salt is present in an amount by weight of the non-water mixture of between 5% and 95%. In examples, the silk fibroin is present in an amount by weight of the non-water mixture of between 5% and 95%. In examples, the chaotropic salt and the silk fibroin are present in the non-water mixture in a weight ratio of chaotropic salt to silk fibroin of between 20:1 and 1:15. The manufacturing method also includes contacting opposing faces of a thin film of the rehydrated adhesive with the low-energy surface and the second surface under pressure to adhere the low-energy surface to the second surface. Contacting may also be at elevated temperature.

In any of the methods or embodiments disclosed herein, the rehydrated adhesive has a viscosity of between 100 cps and 500,000 cps. In some examples, the rehydrated adhesive has a viscosity of between 1000 cps and 250,000 cps. In other examples, the rehydrated adhesive has a viscosity of between 10,000 cps and 100,000 cps.

In any of the methods or embodiments disclosed herein, the low-energy surface is a polyurethane surface, a nylon surface, a polyester surface, a polycarbonate surface, an acrylic surface, or a combination thereof. In some examples, the second surface is a leather surface, an alternative leather surface, a leather-like surface, or a combination thereof. In some examples, the low-energy surface and the second surface are adhered with a peel strength of at least 0.10 N/mm.

In any of the methods or embodiments disclosed herein, at least one of the solid shoe manufacturing adhesive, textile manufacturing adhesive, or solid manufacturing adhesive includes dopamine and/or the silk fibroin is dopamine-modified silk fibroin. In examples, the low-energy surface and the second surface are adhered with a peel strength of at least 1.0 N/mm.

In any of the methods or embodiments disclosed herein, the low-energy surface has a surface energy of less than 80 mJ/m². In any of the methods or embodiments disclosed herein, the low-energy surface has a surface energy of less than 60 mJ/m². In any of the methods or embodiments disclosed herein, the low-energy surface has a surface energy of less than 40 mJ/m². In any of the methods or embodiments disclosed herein, the low-energy surface has a surface energy of less than 20 mJ/m². In any of the methods or embodiments disclosed herein, the low-energy surface has a surface energy of less than 10 mJ/m².

In any of the methods or embodiments disclosed herein, the predetermined rehydration amount of water is between 10% and 100% of a mass of the manufacturing adhesive (e.g., solid shoe manufacturing adhesive, textile manufacturing adhesive, or solid manufacturing adhesive). In examples, the predetermined rehydration amount of water is between 10% and 50% of the mass of the adhesive. In examples, the predetermined rehydration amount of water is between 50% and 100% of the mass of the adhesive. In examples, the predetermined rehydration amount of water is between 10% and 25% of the mass of the adhesive. In examples, the predetermined rehydration amount of water is between 25% and 75% of the mass of the adhesive. In examples, the predetermined rehydration amount of water is between 40% and 65% of the mass of the adhesive. In examples, the predetermined rehydration amount of water is between 60% and 95% of the mass of the adhesive.

In any of the methods or embodiments disclosed herein, adding to produce the rehydrated adhesive is performed in less than 5 minutes, less than 4 minutes, less than 3 minutes, less than 2 minutes, or less than 1 minute. In any of the methods or embodiments disclosed herein, the rehydrated adhesive is produced in less than 5 minutes, less than 4 minutes, less than 3 minutes, less than 2 minutes, or less than 1 minute upon adding a predetermined rehydration amount of water.

In any of the methods or embodiments disclosed herein, the low-energy surface is a polyvinyl acrylate surface, an acetal surface, an ethylene-vinyl acetate surface, a polyethylene surface, a polypropylene surface, a polyvinyl chloride surface, a polytetrafluoroethylene surface, or a combination thereof.

In any of the methods or embodiments disclosed herein, the low-energy surface and the second surface are adhered with a peel strength of at least 0.2 N/mm. In any of the methods or embodiments disclosed herein, the low-energy surface and the second surface are adhered with a peel strength of at least 0.5 N/mm. In any of the methods or embodiments disclosed herein, the low-energy surface and the second surface are adhered with a peel strength of at least 0.8 N/mm. In any of the methods or embodiments disclosed herein, the low-energy surface and the second surface are adhered with a peel strength of at least 1.0 N/mm.

Disclosed herein is a solid shoe manufacturing adhesive. The solid shoe manufacturing adhesive includes a non-water mixture and residual moisture. The non-water mixture includes silk fibroin and a chaotropic salt. In examples, the silk fibroin is present in the non-water mixture in an amount by weight of between 5% and 95%. In examples, the chaotropic salt is present in the non-water mixture in an amount by weight of between 5% and 95% of the non-water mixture. In examples, the chaotropic salt and the silk fibroin are present in a weight ratio of chaotropic salt to silk fibroin of between 15:1 and 1:20.

Disclosed herein is a solid textile manufacturing adhesive. The solid textile manufacturing adhesive includes a non-water mixture and residual moisture. The non-water mixture includes silk fibroin and a chaotropic salt. In examples, the silk fibroin is present in the non-water mixture in an amount by weight of between 5% and 95%. In examples, the chaotropic salt is present in the non-water mixture in an amount by weight of between 5% and 95% of the non-water mixture. In examples, the chaotropic salt and the silk fibroin are present in a weight ratio of chaotropic salt to silk fibroin of between 15:1 and 1:20.

Disclosed herein is a solid manufacturing adhesive. The solid manufacturing adhesive includes a non-water mixture and residual moisture. The non-water mixture includes silk fibroin and a chaotropic salt. In examples, the silk fibroin is present in the non-water mixture in an amount by weight of between 5% and 95%. In examples, the chaotropic salt is present in the non-water mixture in an amount by weight of between 5% and 95% of the non-water mixture. In examples, the chaotropic salt and the silk fibroin are present in a weight ratio of chaotropic salt to silk fibroin of between 15:1 and 1:20.

Disclosed herein is a solid shoe manufacturing adhesive made by dehydrating a silk fibroin solution comprising a chaotropic salt concentration of between 5 mg/mL and 100 mg/mL. The solid shoe manufacturing adhesive includes a non-water mixture and residual moisture. The non-water mixture includes the silk fibroin and the chaotropic salt. The dehydrating inhibits transitions to beta sheet secondary structure and provides one or more of the following properties: i) a predetermined viscosity of between 100 cps and 500,000 cps upon addition of a predetermined viscosity amount of water at a predetermined viscosity temperature, or ii) a predetermined adhesive strength of at least 0.1 N/mm between two predetermined surfaces upon addition of a predetermined adhesive strength amount of water at a predetermined adhesive strength temperature and subsequent contact with the two predetermined surfaces under pressure. The solid shoe manufacturing adhesive is rehydrated in less than 5 minutes, less than 4 minutes, less than 3 minutes, less than 2 minutes, or less than 1 minute under rehydrating conditions.

Disclosed herein is a solid textile manufacturing adhesive made by dehydrating a silk fibroin solution comprising a chaotropic salt concentration of between 5 mg/mL and 100 mg/mL. The solid textile manufacturing adhesive includes a non-water mixture and residual moisture. The non-water mixture includes the silk fibroin and the chaotropic salt. The dehydrating inhibits transitions to beta sheet secondary structure and provides one or more of the following properties: i) a predetermined viscosity of between 100 cps and 500,000 cps upon addition of a predetermined viscosity amount of water at a predetermined viscosity temperature, or ii) a predetermined adhesive strength of at least 0.1 N/mm between two predetermined surfaces upon addition of a predetermined adhesive strength amount of water at a predetermined adhesive strength temperature and subsequent contact with the two predetermined surfaces under pressure. The solid textile manufacturing adhesive is rehydrated in less than 5 minutes, less than 4 minutes, less than 3 minutes, less than 2 minutes, or less than 1 minute under rehydrating conditions.

Disclosed herein is a solid manufacturing adhesive made by dehydrating a silk fibroin solution having dissolved therein chaotropic salts in amounts of between 5 mg/mL and 100 mg/mL. The solid manufacturing adhesive includes a non-water mixture and residual moisture. the non-water mixture comprising the silk fibroin and the chaotropic salt. The dehydrating inhibits transitions to beta sheet secondary structure and provides one or more of the following properties: i) a predetermined viscosity of between 100 cps and 500,000 cps upon addition of a predetermined viscosity amount of water at a predetermined viscosity temperature, or ii) a predetermined adhesive strength of at least 0.1 N/mm between two predetermined surfaces upon addition of a predetermined adhesive strength amount of water at a predetermined adhesive strength temperature and subsequent contact with the two predetermined surfaces under pressure. The solid manufacturing adhesive is rehydrated in less than 5 minutes, less than 4 minutes, less than 3 minutes, less than 2 minutes, or less than 1 minute under rehydrating conditions.

The term adhesive as utilized herein should be understood broadly and may be used to refer to any of the disclosed adhesives herein, including the solid shoe manufacturing adhesive, solid textile manufacturing adhesive, or solid manufacturing adhesive. One of skill in the art, having the benefit of the disclosure herein and knowledge about a contemplated application ordinarily available to that person, can readily determine which aspects of the present disclosure will benefit a particular application and how to choose disclosed adhesives from the present disclosure to use in particular applications. Certain considerations for the person of skill in the art in determining the adhesive to use include, without limitation: the type of surface, the arrangement of surfaces, the size of the surface, the energy of the surfaces, the type of textile, the type of solid object, or environmental considerations such as temperature, pressure, and humidity. While specific examples and considerations are described herein for purposes of illustration, any system, method, or application benefitting from the disclosures herein, and any considerations understood to one of skill in the art having the benefit of the disclosures herein, are specifically contemplated within the scope of the present disclosure.

In examples of adhesives disclosed herein, the predetermined viscosity is between 100 cps and 250,000 cps. In examples of adhesives disclosed herein, the predetermined viscosity is between 1000 cps and 100,000 cps.

In examples of adhesives disclosed herein, the predetermined viscosity amount of water is between 10% and 100% of a mass of the adhesive. For example, the predetermined viscosity amount of water is between 10% and 50% of the mass of the adhesive, between 50% and 100% of the mass of the adhesive, between 10% and 25% of the mass of the adhesive, between 25% and 75% of the mass of the adhesive, between 40% and 65% of the mass of the adhesive, or between 60% and 95% of the mass of the adhesive.

In examples of adhesives disclosed herein, the predetermined adhesive strength amount of water is between 10% and 100% of a mass of the solid shoe manufacturing adhesive. For example, the predetermined adhesive strength amount of water is between 10% and 50% of the mass of the adhesive, between 50% and 100% of the mass of the adhesive, between 10% and 25% of the mass of the adhesive, between 25% and 75% of the mass of the adhesive, between 40% and 65% of the mass of the adhesive, or between 60% and 95% of the mass of the adhesive.

In examples of adhesives disclosed herein, the predetermined viscosity temperature is between 20° C. and 150° C. For example, the predetermined viscosity temperature is between 20° C. and 50° C., between 50° C. and 150° C., between 25° C. and 90° C., between 60° C. and 120° C., between 30° C. and 75° C., or between 45° C. and 100° C.

In examples of adhesives disclosed herein, the predetermined adhesive strength temperature is between 20° C. and 150° C. For example, the predetermined adhesive strength temperature is between 50° C. and 150° C., between 25° C. and 90° C., between 60° C. and 120° C., between 30° C. and 75° C., between 45° C. and 100° C., or between 20° C. and 150° C.

In examples of the methods or adhesives disclosed herein, the silk fibroin has a molecular weight distribution including a weight average molecular weight of between 25 kDa and 150 kDa, between 30 kDa and 100 kDa, or between 35 kDa and 75 kDa.

In examples of the methods or adhesives disclosed herein, the non-water mixture comprises a plasticizer. For example, the plasticizer is glycerol. In another example, the plasticizer is present in the non-water mixture in an amount by weight of between 1% and 50%, between 1% and 25%, or between 1% and 5% of the non-water mixture.

In examples of the methods or adhesives disclosed herein, the adhesive is not adhesive to human skin, is not sticky when handled by human hands, or a combination thereof.

In examples of the methods or adhesives disclosed herein, the silk fibroin comprises silk fibroin fragments cross-linked to other silk fibroin fragments.

In examples of the methods or adhesives disclosed herein, the silk fibroin is a covalently modified silk fibroin. For example, the covalently modified silk fibroin is a dopamine-modified silk fibroin, an acrylate-modified silk fibroin, a gallic acid-modified silk fibroin, a phoroglucinol-modified silk fibroin, or a carbamate-modified silk fibroin.

In examples of the methods or adhesives disclosed herein, the silk fibroin is cross-linked to a functional moiety.

In examples of the methods or adhesives disclosed herein, the non-water mixture comprises an additive. For example, the additive is bisphenol A, an enzyme (e.g., horseradish peroxidase, tyrosinase, lactase), or acrylic acid. In other examples, the additive is or comprises dopamine.

In examples of the methods or adhesives disclosed herein, the chaotropic salt is present in an amount by weight of the non-water mixture of between 5% and 25%. In examples of the methods or adhesives disclosed herein, the chaotropic salt is present in an amount by weight of the non-water mixture of between 15% and 45%. In examples of the methods or adhesives disclosed herein, the chaotropic salt is present in an amount by weight of the non-water mixture of between 25% and 50%. In examples of the methods or adhesives disclosed herein, the chaotropic salt is present in an amount by weight of the non-water mixture of between 50% and 75%. In examples of the methods or adhesives disclosed herein, the chaotropic salt is present in an amount by weight of the non-water mixture of between 60% and 90%. In examples of the methods or adhesives disclosed herein, the chaotropic salt is present in an amount by weight of the non-water mixture of between 40% and 65%. In examples of the methods or adhesives disclosed herein, the chaotropic salt is present in an amount by weight of the non-water mixture of between 25% and 80%. In some cases, the chaotropic salt is present in an amount by weight of the non-water mixture of between a lower bound of one of the ranges listed in this paragraph and an upper bound of a different range listed in this paragraph, so long as those two bounds are not the same (note: this includes instances where the lower bound in one range is a larger value than the upper bound in another range, with the lower bound in one range becoming the upper bound in the new range and the upper bound in the another range becoming the lower bound in the new range).

In examples of the methods or adhesives disclosed herein, the silk fibroin is present in an amount by weight of the non-water mixture of between 5% and 25%. In examples of the methods or adhesives disclosed herein, the silk fibroin is present in an amount by weight of the non-water mixture of between 15% and 45%. In examples of the methods or adhesives disclosed herein, the silk fibroin is present in an amount by weight of the non-water mixture of between 25% and 50%. In examples of the methods or adhesives disclosed herein, the silk fibroin is present in an amount by weight of the non-water mixture of between 50% and 75%. In examples of the methods or adhesives disclosed herein, the silk fibroin is present in an amount by weight of the non-water mixture of between 60% and 90%. In examples of the methods or adhesives disclosed herein, the silk fibroin is present in an amount by weight of the non-water mixture of between 40% and 65%. In examples of the methods or adhesives disclosed herein, the silk fibroin is present in an amount by weight of the non-water mixture of between 25% and 80%. In some cases, the silk fibroin is present in an amount by weight of the non-water mixture of between a lower bound of one of the ranges listed in this paragraph and an upper bound of a different range listed in this paragraph, so long as those two bounds are not the same (note: this includes instances where the lower bound in one range is a larger value than the upper bound in another range, with the lower bound in one range becoming the upper bound in the new range and the upper bound in the another range becoming the lower bound in the new range).

In examples of the methods or adhesives disclosed herein, the weight ratio of chaotropic salt to silk fibroin is between 2:1 and 1:10. In examples of the methods or adhesives disclosed herein, the weight ratio of chaotropic salt to silk fibroin is between 5:1 and 1:10. In examples of the methods or adhesives disclosed herein, the weight ratio of chaotropic salt to silk fibroin is between 2:1 and 1:5. In examples of the methods or adhesives disclosed herein, the weight ratio of chaotropic salt to silk fibroin is between 2:1 and 1:2. In examples of the methods or adhesives disclosed herein, the weight ratio of chaotropic salt to silk fibroin is between 1:1 and 1:5. In examples of the methods or adhesives disclosed herein, the weight ratio of chaotropic salt to silk fibroin is between 2:1 and 1:1. In examples of the methods or adhesives disclosed herein, wherein the weight ratio of chaotropic salt to silk fibroin is between 1:1 and 1:2.

According to various embodiments, a variety of functionalizing agents may be used with the silk-containing embodiments described herein (e.g., silk membrane, silk composition, silk matrix, silk foam, silk microsphere, etc.). It should be understood that the examples herein may recite one or a few silk-containing embodiments but are applicable to any silk-containing embodiment, as applicable.

According to various embodiments, any application-appropriate amount of one or more functionalizing agents may be used. In some embodiments, the amount of an individual functionalizing agent may be between about 1 μg/ml and 1,000 μg/ml (e.g., between about 2 and 1,000, 5 and 1,000, 10 and 1,000, 10 and 500, 10 and 100 μg/m1). In some embodiments, the amount of an individual functionalizing agent may be at least 1 μg/ml (e.g., at least 5, 10, 15, 20 25, 50, 100, 200, 300 400, 500, 600, 700, 800, or 900 μ/ml). In some embodiments, the amount of an individual functionalizing agent is at most 1,000 μg/ml (e.g., 900, 800, 700, 600, 500, 400, 300 200, 100, 90, 80, 70, 60, 50, 40, 30, 20, 10, or 5 μ/ml).

In some aspects, the composition comprises one or more sensing agents, such as a sensing dye. The sensing agents/sensing dyes are environmentally sensitive and produce a measurable response to one or more environmental factors. In some aspects, the environmentally-sensitive agent or dye may be present in the composition in an effective amount to alter the composition from a first chemical-physical state to a second chemical-physical state in response to an environmental parameter (e.g., a change in pH, light intensity or exposure, temperature, pressure or strain, voltage, physiological parameter of a subject, and/or concentration of chemical species in the surrounding environment) or an externally applied stimulus (e.g., optical interrogation, acoustic interrogation, and/or applied heat). In some cases, the sensing dye is present to provide one optical appearance under one given set of environmental conditions and a second, different optical appearance under a different given set of environmental conditions. Suitable concentrations for the sensing agents described herein can be the concentrations for the colorants and additives described elsewhere herein. A person having ordinary skill in the chemical sensing arts can determine a concentration that is appropriate for use in a sensing application of the inks described herein.

In some aspects, the first and second chemical-physical state may be a physical property of the composition, such as mechanical property, a chemical property, an acoustical property, an electrical property, a magnetic property, an optical property, a thermal property, a radiological property, or an organoleptic property. Exemplary sensing dyes or agents include, but are not limited to, a pH sensitive agent, a thermal sensitive agent, a pressure or strain sensitive agent, a light sensitive agent, or a potentiometric agent.

Exemplary pH sensitive dyes or agents include, but are not limited to, cresol red, methyl violet, crystal violet, ethyl violet, malachite green, methyl green, 2-(p-dimethylaminophenylazo) pyridine, paramethyl red, metanil yellow, 4-phenylazodiphenylamine, thymol blue, metacresol purple, orange IV, 4-o-Tolylazo-o-toluindine, quinaldine red, 2,4-dinitrophenol, erythrosine disodium salt, benzopurpurine 4B, N,N-dimethyl-p-(m-tolylazo) aniline, p-dimethylaminoazobenene, 4,4′-bis(2-amino-1-naphthylazo)-2,2′-stilbenedisulfonic acid, tetrabromophenolphthalein ethyl ester, bromophenol blue, Congo red, methyl orange, ethyl orange, 4-(4-dimethylamino-1-naphylazo)-3-methoxybenesulfonic acid, bromocresol green, resazurin, 4-phenylazo-1-napthylamine, ethyl red 2-([-dimethylaminophenyazo) pyridine, 4-(p-ethoxypehnylazo)-m-phenylene-diamine monohydrochloride, resorcin blue, alizarin red S, methyl red, propyl red, bromocresol purple, chlorophenol red, p-nitrophenol, alizarin 2-(2,4-dinitrophenylazo) 1-napthol-3,6-disulfonic acid, bromothymol blue, 6,8-dinitro-2,4-(1H) quinazolinedione, brilliant yellow, phenol red, neutral red, m-nitrophenol, cresol red, turmeric, metacresol purple, 4,4′-bis(3-amino-1-naphthylazo)-2,2′-stilbenedisulfonic acid, thymol blue, p-naphtholbenzein, phenolphthalein, o-cresolphthalein, ethyl bis(2,4-dimethylphenyl) ethanoate, thymolphthalein, nitrazine yellow, alizarin yellow R, alizarin, p-(2,4-dihydroxyphenylazo) benzenesulfonic acid, 5,5′-indigodisulfonic acid, 2,4,6-trinitrotoluene, 1,3,5-trinitrobenezne, and clayton yellow.

Exemplary light responsive dyes or agents include, but are not limited to, photochromic compounds or agents, such as triarylmethanes, stilbenes, azasilbenes, nitrones, fulgides, spiropyrans, napthopyrans, spiro-oxzines, quinones, derivatives and combinations thereof.

Exemplary potentiometric dyes include, but are not limited to, substituted amiononaphthylehenylpridinium (ANEP) dyes, such as di-4-ANEPPS, di-8-ANEPPS, and N-(4-Sulfobutyl)-4-(6-(4-(Dibutylamino)phenyl)hexatrienyl)Pyridinium (RH237).

Exemplary temperature sensitive dyes or agents include, but are not limited to, thermochromic compounds or agents, such as thermochromic liquid crystals, leuco dyes, fluoran dyes, octadecylphosphonic acid.

Exemplary pressure or strain sensitive dyes or agents include, but are not limited to, spiropyran compounds and agents.

Exemplary chemi-sensitive dyes or agents include, but are not limited to, antibodies such as immunoglobulin G (IgG) which may change color from blue to red in response to bacterial contamination.

In some aspects, the compositions comprise one or more additive, dopant, or biologically active agent suitable for a desired intended purpose. In some aspects, the additive or dopant may be present in the composition in an amount effective to impart an optical or organoleptic property to the composition. Exemplary additives or dopants that impart optical or organoleptic properties include, but are not limited to, dyes/pigments, flavorants, aroma compounds, granular or fibrous fillers.

Additionally or alternatively, the additive, dopant, or biologically active agent may be present in the composition in an amount effective to “functionalize” the composition to impart a desired mechanical property or added functionality to the composition. Exemplary additive, dopants, or biologically active agent that impart the desired mechanical property or added functionality include, but are not limited to: environmentally sensitive/sensing dyes; active biomolecules; conductive or metallic particles; micro and nanofibers (e.g., silk nanofibers for reinforcement, carbon nanofibers); nanotubes; inorganic particles (e.g., hydroxyapatite, tricalcium phosphate, bioglasses); drugs (e.g., antibiotics, small molecules or low molecular weight organic compounds); proteins and fragments or complexes thereof (e.g., enzymes, antigens, antibodies and antigen-binding fragments thereof); DNA/RNA (e.g., siRNA, miRNA, mRNA); cells and fractions thereof (viruses and viral particles; prokaryotic cells such as bacteria; eukaryotic cells such as mammalian cells and plant cells; fungi).

In some aspects, the additive or dopant comprises a flavoring agent or flavorant.

Exemplary flavorants include ester flavorants, amino acid flavorants, nucleic acid flavorants, organic acid flavorants, and inorganic acid flavorants, such as, but not limited to, diacetyl, acetylpropionyl, acetoin, isoamyl acetate, benzaldehyde, cinnamaldehyde, ethyl propionate, methyl anthranilate, limonene, ethyl decadienoate, allyl hexanoate, ethyl maltol, ethylvanillin, methyl salicylate, manzanate, glutamic acid salts, glycine salts, guanylic acids salts, inosinic acid salts, acetic acid, ascorbic acid, citric acid, fumaric acid, lactic acid, malic acid, phosphoric acid, tartaric acid, derivatives, and mixtures thereof.

In some aspects, the additive or dopant comprises an aroma compound. Exemplary aroma compounds include ester aroma compounds, terpene aroma compounds, cyclic terpenes, and aromatic aroma compounds, such as, but not limited to, geranyl acetate, methyl formate, metyl acetate, methyl propionate, methyl butyrate, ethyl acetate, ethyl butyrate, isoamyl acetate, pentyl butrate, pentyl pentanoate, octyl acetate, benzyl acetate, methyl anthranilate, myrecene, geraniol, nerol, citral, cironellal, cironellol, linalool, nerolidol, limonene, camphor, menthol, carone, terpineol, alpha-lonone, thujone, eucalyptol, benzaldehyde, eugenol, cinnamaldehyde, ethyl maltol, vanillin, anisole, anethole, estragole, thymol.

In some aspects, the additive or dopant comprises a colorant, such as a dye or pigment. In some aspects, the dye or pigment imparts a color or grayscale to the composition. The colorant can be different than the sensing agents and/or sensing dyes below. Any organic and/or inorganic pigments and dyes can be included in the inks. Exemplary pigments suitable for use in the present disclosure include International Color Index or C.I. Pigment Black Numbers 1, 7, 1 1 and 31, C.I. Pigment Blue Numbers 15, 15: 1, 15: 2, 15: 3, 15: 4, 15: 6, 16, 27, 29, 61 and 62, C.I. Pigment Green Numbers 7, 17, 18 and 36, C.I. Pigment Orange Numbers 5, 13, 16, 34 and 36, C.I. Pigment Violet Numbers 3, 19, 23 and 27, C.I. Pigment Red Numbers 3, 17, 22, 23, 48: 1, 48: 2, 57: 1, 81: 1, 81: 2, 81: 3, 81: 5, 101, 1 14, 122, 144, 146, 170, 176, 179, 181, 185, 188, 202, 206, 207, 210 and 249, C.I. Pigment Yellow Numbers 1, 2, 3, 12, 13, 14, 17, 42, 65, 73, 74, 75, 83, 30, 93, 109, 1 10, 128, 138, 139, 147, 142, 151, 154 and 180, D&C Red No. 7, D&C Red No. 6 and D&C Red No. 34, carbon black pigment (such as Regal 330, Cabot Corporation), quinacridone pigments (Quinacridone Magenta (228-0122), available from Sun Chemical Corporation, Fort Lee, N.J.), diarylide yellow pigment (such as AAOT Yellow (274-1788) available from Sun Chemical Corporation); and phthalocyanine blue pigment (such as Blue 15:3 (294-1298) available from Sun Chemical Corporation). The classes of dyes suitable for use in present invention can be selected from acid dyes, natural dyes, direct dyes (either cationic or anionic), basic dyes, and reactive dyes. The acid dyes, also regarded as anionic dyes, are soluble in water and mainly insoluble in organic solvents and are selected, from yellow acid dyes, orange acid dyes, red acid dyes, violet acid dyes, blue acid dyes, green acid dyes, and black acid dyes. European Patent 0745651, incorporated herein by reference, describes a number of acid dyes that are suitable for use in the present disclosure. Exemplary yellow acid dyes include Acid Yellow 1 International Color Index or C.I. 10316); Acid Yellow 7 (C.I. 56295); Acid Yellow 17 (C.I. 18965); Acid Yellow 23 (C.I. 19140); Acid Yellow 29 (C.I. 18900); Acid Yellow 36 (C.I. 13065); Acid Yellow 42 (C.I. 22910); Acid Yellow 73 (C.I. 45350); Acid Yellow 99 (C.I. 13908); Acid Yellow 194; and Food Yellow 3 (C.I. 15985). Exemplary orange acid dyes include Acid Orange 1 (C.I. 13090/1); Acid Orange 10 (C.I. 16230); Acid Orange 20 (C.I. 14603); Acid Orange 76 (C.I. 18870); Acid Orange 142; Food Orange 2 (C.I. 15980); and Orange B.

Exemplary red acid dyes include Acid Red 1. (C.I. 18050); Acid Red 4 (C.I. 14710); Acid Red 18 (C.I. 16255), Acid Red 26 (C.I. 16150); Acid Red 2.7 (C.I. as Acid Red 51 (C.I. 45430, available from BASF Corporation, Mt. Olive, N.J.) Acid Red 52 (C.I. 45100); Acid Red 73 (C.I. 27290); Acid Red 87 (C. I. 45380); Acid Red 94 (C.I. 45440) Acid Red 194; and Food Red 1 (C.I. 14700). Exemplary violet acid dyes include Acid Violet 7 (C.I. 18055); and Acid Violet 49 (C.I. 42640). Exemplary blue acid dyes include Acid Blue 1 (C.I. 42045); Acid Blue 9 (C.I. 42090); Acid Blue 22 (C.I. 42755); Acid Blue 74 (C.I. 73015); Acid Blue 93 (C.I. 42780); and Acid Blue 158A (C.I. 15050). Exemplary green acid dyes include Acid Green 1 (C.I. 10028); Acid Green 3 (C.I. 42085); Acid Green 5 (C.I. 42095); Acid Green 26 (C.I. 44025); and Food Green 3 (C.I. 42053). Exemplary black acid dyes include Acid Black 1 (C.I. 20470); Acid Black 194 (Basantol® X80, available from BASF Corporation, an azo/1: 2 CR-complex.

Exemplary direct dyes for use in the present disclosure include Direct Blue 86 (C.I. 74180); Direct Blue 199; Direct Black 168; Direct Red 253; and Direct Yellow 107/132 (C.I. Not Assigned).

Exemplary natural dyes for use in the present disclosure include Alkanet (C.I. 75520,75530); Annafto (C.I. 75120); Carotene (C.I. 75130); Chestnut; Cochineal (C.I. 75470); Cutch (C.I. 75250, 75260); Divi-Divi; Fustic (C.I. 75240); Hypernic (C.I. 75280); Logwood (C.I. 75200); Osage Orange (C.I. 75660); Paprika; Quercitron (C.I. 75720); Sanrou (C.I. 75100); Sandal Wood (C.I. 75510, 75540, 75550, 75560); Sumac; and Tumeric (C.I. 75300). Exemplary reactive dyes for use in the present disclosure include Reactive Yellow 37 (monoazo dye); Reactive Black 31 (disazo dye); Reactive Blue 77 (phthalo cyanine dye) and Reactive Red 180 and Reactive Red 108 dyes. Suitable also are the colorants described in The Printing Ink Manual (5th ed., Leach et al. eds. (2007), pages 289-299. Other organic and inorganic pigments and dyes and combinations thereof can be used to achieve the colors desired.

In addition to or in place of visible colorants, compositions provided herein can contain ETV fluorophores that are excited in the ETV range and emit light at a higher wavelength (typically 400 nm and above). Examples of ETV fluorophores include but are not limited to materials from the coumarin, benzoxazole, rhodamine, napthalimide, perylene, benzanthrones, benzoxanthones or benzothia-xanthones families. The addition of a UV fluorophore (such as an optical brightener for instance) can help maintain maximum visible light transmission. The amount of colorant, when present, generally is between 0.05% to 5% or between 0.1% and 1% based on the weight of the composition.

For non-white compositions, the amount of pigment/dye generally is present in an amount of from at or about 0.1 wt % to at or about 20 wt % based on the weight of the composition. In some applications, a non-white ink can include 15 wt % or less pigment/dye, or 10 wt % or less pigment/dye or 5 wt % pigment/dye, or 1 wt % pigment/dye based on the weight of the composition. In some applications, a non-white ink can include 1 wt % to 10 wt %, or 5 wt % to 15 wt %, or 10 wt % to 20 wt % pigment/dye based on the weight of the composition. In some applications, a non-white ink can contain an amount of dye/pigment that is 1 wt %, 2 wt %, 3 wt %, 4 wt %, 5%, 6 wt %, 7 wt %, 8 wt %, 9 wt %, 10 wt %, 11 wt %, 12 wt %, 13 wt %, 14 wt %, 15%, 16 wt %, 17 wt %, 18 wt %, 19 wt % or 20 wt % based on the weight of the composition.

For white compositions, the amount of white pigment generally is present in an amount of from at or about 1 wt % to at or about 60 wt % based on the weight of the composition. In some applications, greater than 60 wt % white pigment can be present. Preferred white pigments include titanium dioxide (anatase and rutile), zinc oxide, lithopone (calcined coprecipitate of barium sulfate and zinc sulfide), zinc sulfide, blanc fixe and alumina hydrate and combinations thereof, although any of these can be combined with calcium carbonate. In some applications, a white ink can include 60 wt % or less white pigment, or 55 wt % or less white pigment, or 50 wt % white pigment, or 45 wt % white pigment, or 40 wt % white pigment, or 35 wt % white pigment, or 30 wt % white pigment, or 25 wt % white pigment, or 20 wt % white pigment, or 15 wt % white pigment, or 10 wt % white pigment, based on the weight of the composition. In some applications, a white ink can include 5 wt % to 60 wt %, or 5 wt % to 55 wt %, or 10 wt % to 50 wt %, or 10 wt % to 25 wt %, or 25 wt % to 50 wt %, or 5 wt % to 15 wt %, or 40 wt % to 60 wt % white pigment based on the weight of the composition. In some applications, a non-white ink can an amount of dye/pigment that is 5%, 6 wt %, 7 wt %, 8 wt %, 9 wt %, 10 wt %, 11 wt %, 12 wt %, 13 wt %, 14 wt %, 15%, 16 wt %, 17 wt %, 18 wt %, 19 wt %, 20 wt %, 21 wt %, 22 wt %, 23 wt %, 24 wt %, 25%, 26 wt %, 27 wt %, 28 wt %, 29 wt %, 30 wt %, 31 wt %, 32 wt %, 33 wt %, 34 wt %, 35%, 36 wt %, 37 wt %, 38 wt %, 39 wt %, 40 wt %, 41 wt %, 42 wt %, 43 wt %, 44 wt %, 45%, 46 wt %, 47 wt %, 48 wt %, 49 wt %, 50 wt %, 51 wt %, 52 wt %, 53 wt %, 54 wt %, 55%, 56 wt %, 57 wt %, 58 wt %, 59 wt % or 60 wt % based on the weight of the composition.

In some aspects, the additive or dopant comprises a conductive additive. Exemplary conductive additives include, but are not limited to graphite, graphite powder, carbon nanotubes, and metallic particles or nanoparticles, such as gold nanoparticles. In some aspects, the conductive additive is biocompatible and non-toxic.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, any of the features or functions of any of the embodiments disclosed herein may be incorporated into any of the other embodiments disclosed herein.

### EXAMPLES

Starting from a 1-12% solution of silk fibroin, chaotropic salts (such as MgCl₂ or CaCl₂) are dissolved in the solution in concentrations between 5 mg/ml and 100 mg/ml to inhibit the transition to beta-sheet secondary structure and keep the silk mainly in a state of random coils. This means that, even when dried, the silk can be completely rehydrated by controlling its viscosity (FIG. 1 A, B), which can be accomplished by adding the desired volume of water to the film and heating (e.g., for a few minutes) to speed up the process.

The chaotropic salt content in the silk solid determines the rate at which it redissolves in water, and this also affects the final properties of the adhesive depending on whether a washable or water-resistant adhesive is desired. The process is also compatible with the addition of other molecules to the silk solution which can increase the adhesive strength or add properties such as water resistance (e.g., dopamine or gallic acid), increase the flexibility of the adhesive (e.g., plasticizers), or increase its toughness (e.g., crosslinkers).

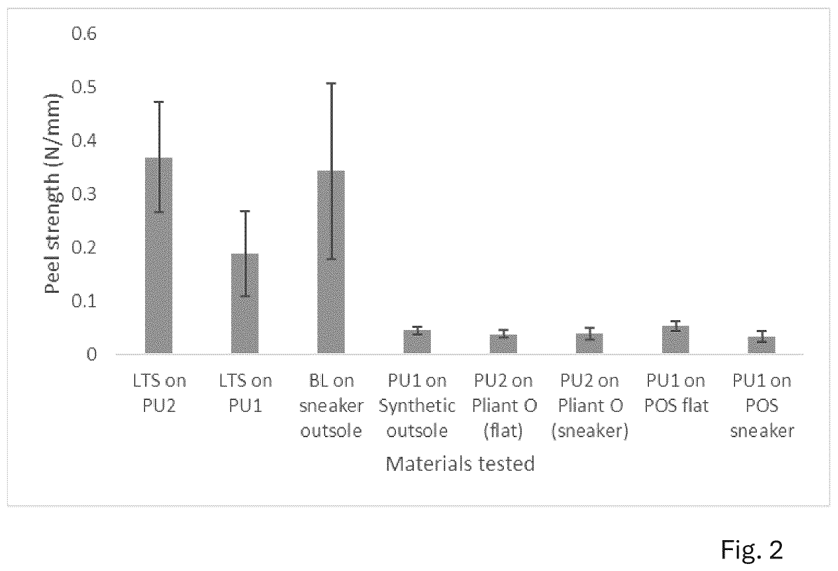

Adhesion tests (T-Peel tests) were performed on different materials commonly used in footwear such as Leather top sheets (LTS and BL). two types of plant-based polyurethane (PU) (PU1 and PU2), and different materials for outsole (sneaker, synthetic and Pliant). In the conditions used for the measurements, the force values required are 1 N/mm and the results (FIG. 2) fall within an order of magnitude of those required.

The adhesion of this new formulation compared to the previously reported solid silk films shows markedly different performance when applied on low surface energy materials: while pure silk or silk and dopamine films show excellent adhesion on metals and glass (high energy surfaces) their performance on plastics and rubbers is substantially absent (unable to bond the two substrates). The adhesive obtained by SF and salts dissolution instead shows a measurable adhesion on any kind of materials tested. Without wishing to be bound to any particular theory, this is likely because of the adhesive's phase being more reminiscent to a liquid which allows improved spreading and higher contact between the two layers of adherence.

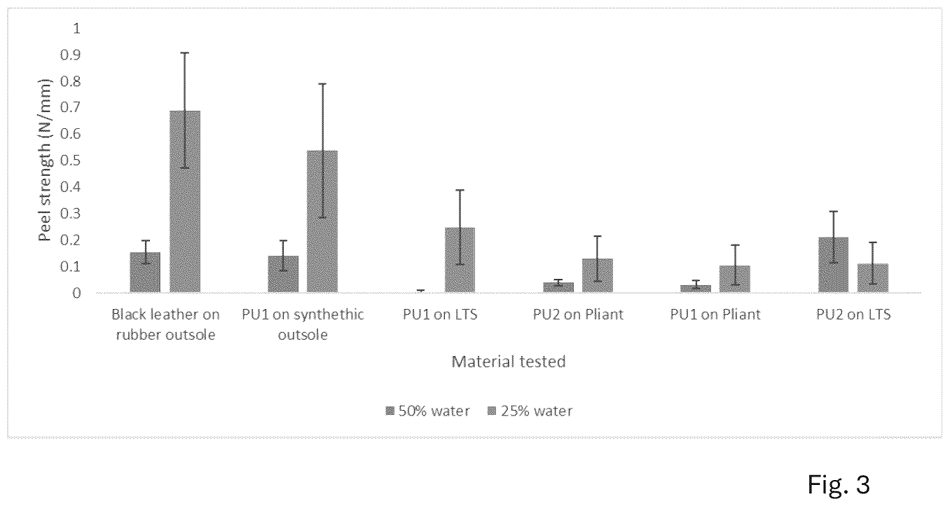

To measure the influence of viscosity on adhesion, a 9.3% silk solution containing 50 mg/mL CaCl₂ was dried (a ratio of salt to SF of approximately 1:2). The solid was then redissolved with a quantity of water equal to 50% or 25% of its total mass and the performance of the two adhesives was measured through T-Peel tests on different materials (FIG. 3). In most cases, the adhesive with a lower water content has higher adhesion with increases that depend on the type of materials used. However, on a combination of materials tested, the more diluted version of the adhesive showed better performance, suggesting that different materials require different dilutions to obtain the best initial performance.

In addition to the features described above and elsewhere herein, the present disclosure also includes the following clauses:
1. A shoe manufacturing method comprising adhering a low-energy surface of a first shoe part to a second surface of a second shoe part, wherein the low-energy surface has a surface energy less than 100 mJ/m², the shoe manufacturing method comprising:
   a) adding a predetermined rehydration amount of water to a solid shoe manufacturing adhesive at a predetermined rehydration temperature to produce a rehydrated adhesive, optionally in less than 5 minutes, less than 4 minutes, less than 3 minutes, less than 2 minutes, or less than 1 minute, the solid shoe manufacturing adhesive comprising a non-water mixture and residual moisture, the non-water mixture comprising silk fibroin and a chaotropic salt, wherein the chaotropic salt is present in an amount by weight of the non-water mixture of between 5% and 95%, wherein the silk fibroin is present in an amount by weight of the non-water mixture of between 5% and 95%, wherein the chaotropic salt and the silk fibroin are present in the non-water mixture in a weight ratio of chaotropic salt to silk fibroin of between 20:1 and 1:15; and
   b) contacting opposing faces of a thin film of the rehydrated adhesive with the low-energy surface and the second surface under pressure and optionally at elevated temperature to adhere the low-energy surface to the second surface.
2. A textile manufacturing method comprising adhering a low-energy surface of a first textile to a second surface of the first textile or a second textile, wherein the low-energy surface has a surface energy less than 100 mJ/m², the textile manufacturing method comprising:
   a) adding a predetermined rehydration amount of water to a textile manufacturing adhesive at a predetermined rehydration temperature to produce a rehydrated adhesive, optionally in less than 5 minutes, less than 4 minutes, less than 3 minutes, less than 2 minutes, or less than 1 minute, the textile manufacturing adhesive comprising a non-water mixture and residual moisture, the non-water mixture comprising silk fibroin and a chaotropic salt, wherein the chaotropic salt is present in an amount by weight of the non-water mixture of between 5% and 95%, wherein the silk fibroin is present in an amount by weight of the non-water mixture of between 5% and 95%, wherein the chaotropic salt and the silk fibroin are present in the non-water mixture in a weight ratio of chaotropic salt to silk fibroin of between 20:1 and 1:15; and
   b) contacting opposing faces of a thin film of the rehydrated adhesive with the low-energy surface and the second surface under pressure and optionally at elevated temperature to adhere the low-energy surface to the second surface.
3. A manufacturing method comprising adhering a low-energy surface to a second surface, wherein the low-energy surface has a surface energy less than 100 mJ/m2, the manufacturing method comprising:
   a) adding a predetermined rehydration amount of water to a solid manufacturing adhesive at a predetermined rehydration temperature to produce a rehydrated adhesive, optionally in less than 5 minutes, less than 4 minutes, less than 3 minutes, less than 2 minutes, or less than 1 minute, the solid manufacturing adhesive comprising a non-water mixture and residual moisture, the non-water mixture comprising silk fibroin and a chaotropic salt, wherein the chaotropic salt is present in an amount by weight of the non-water mixture of between 5% and 95%, wherein the silk fibroin is present in an amount by weight of the non-water mixture of between 5% and 95%, wherein the chaotropic salt and the silk fibroin are present in the non-water mixture in a weight ratio of chaotropic salt to silk fibroin of between 20:1 and 1:15; and
   b) contacting opposing faces of a thin film of the rehydrated adhesive with the low-energy surface and the second surface under pressure and optionally at elevated temperature to adhere the low-energy surface to the second surface.
4. The method of any one of clauses 1 to the immediately preceding clause, wherein the rehydrated adhesive has a viscosity of between 100 cps and 500,000 cps.
5. The method of clause 4, wherein the rehydrated adhesive has a viscosity of between 1000 cps and 250,000 cps.
6. The method of clause 4, wherein the rehydrated adhesive has a viscosity of between 10,000 cps and 100,000 cps.
7. The method of any one of clauses 1 to the immediately preceding clause, wherein the low-energy surface is a polyurethane surface, a nylon surface, a polyester surface, a polycarbonate surface, an acrylic surface, or a combination thereof.
8. The method of clause 7, wherein the second surface is a leather surface, an alternative leather surface, a leather-like surface, or a combination thereof.
9. The method of clause 8, wherein the low-energy surface and the second surface are adhered with a peel strength of at least 0.10 N/mm.
10. The method of any one of clauses 1 to the immediately preceding clause, wherein at least one of the solid shoe manufacturing adhesive, textile manufacturing adhesive, or solid manufacturing adhesive comprises dopamine and/or the silk fibroin is dopamine-modified silk fibroin.
11. The method of clause 10, wherein the low-energy surface and the second surface are adhered with a peel strength of at least 1.0 N/mm.
12. The method of any one of clauses 1 to the immediately preceding clause, wherein the low-energy surface has a surface energy of less than 80 mJ/m².
13. The method of any one of clauses 1 to the immediately preceding clause, wherein the low-energy surface has a surface energy of less than 60 mJ/m².
14. The method of any one of clauses 1 to the immediately preceding clause, wherein the low-energy surface has a surface energy of less than 40 mJ/m².
15. The method of any one of clauses 1 to the immediately preceding clause, wherein the low-energy surface has a surface energy of less than 20 mJ/m².
16. The method of any one of clauses 1 to the immediately preceding clause, wherein the low-energy surface has a surface energy of less than 10 mJ/m².
17. The method of any one of clauses 1 to the immediately preceding clause, wherein the predetermined rehydration amount of water is between 10% and 100% of a mass of the solid shoe manufacturing adhesive.
18. The method of clause 17, wherein the predetermined rehydration amount of water is between 10% and 50% of the mass of the solid shoe manufacturing adhesive.
19. The method of clause 17, wherein the predetermined rehydration amount of water is between 50% and 100% of the mass of the solid shoe manufacturing adhesive.
20. The method of clause 17, wherein the predetermined rehydration amount of water is between 10% and 25% of the mass of the solid shoe manufacturing adhesive.
21. The method of clause 17, wherein the predetermined rehydration amount of water is between 25% and 75% of the mass of the solid shoe manufacturing adhesive.
22. The method of clause 17, wherein the predetermined rehydration amount of water is between 40% and 65% of the mass of the solid shoe manufacturing adhesive.
23. The method of clause 17, wherein the predetermined rehydration amount of water is between 60% and 95% of the mass of the solid shoe manufacturing adhesive.
24. The method of any one of clauses 1 to the immediately preceding clause, wherein the adding to produce the rehydrated adhesive is performed in less than 5 minutes, less than 4 minutes, less than 3 minutes, less than 2 minutes, or less than 1 minute.
25. The method of any one of clauses 1 to the immediately preceding clause, wherein the adding to produce the rehydrated adhesive is performed in less than 1 minute.
26. The method of any one of clauses 1 to the immediately preceding clause, wherein the low-energy surface is a polyvinyl acrylate surface, an acetal surface, an ethylene-vinyl acetate surface, a polyethylene surface, a polypropylene surface, a polyvinyl chloride surface, a polytetrafluoroethylene surface, or a combination thereof.
27. The method of any one of clauses 1 to the immediately preceding clause, wherein the low-energy surface and the second surface are adhered with a peel strength of at least 0.2 N/mm.
28. The method of any one of clauses 1 to the immediately preceding clause, wherein the low-energy surface and the second surface are adhered with a peel strength of at least 0.5 N/mm.
29. The method of any one of clauses 1 to the immediately preceding clause, wherein the low-energy surface and the second surface are adhered with a peel strength of at least 0.8 N/mm.
30. The method of any one of clauses 1 to the immediately preceding clause, wherein the low-energy surface and the second surface are adhered with a peel strength of at least 1.0 N/mm.
31. A solid shoe manufacturing adhesive comprising a non-water mixture and residual moisture, the non-water mixture comprising silk fibroin and a chaotropic salt, wherein:
the silk fibroin is present in the non-water mixture in an amount by weight of between 5% and 95% and the chaotropic salt is present in the non-water mixture in an amount by weight of between 5% and 95% of the non-water mixture; and
the chaotropic salt and the silk fibroin are present in a weight ratio of chaotropic salt to silk fibroin of between 15:1 and 1:20.
32. A solid textile manufacturing adhesive comprising a non-water mixture and residual moisture, the non-water mixture comprising silk fibroin and a chaotropic salt, wherein:
the silk fibroin is present in the non-water mixture in an amount by weight of between 5% and 95% and the chaotropic salt is present in the non-water mixture in an amount by weight of between 5% and 95% of the non-water mixture; and
the chaotropic salt and the silk fibroin are present in a weight ratio of chaotropic salt to silk fibroin of between 15:1 and 1:20.
33. A solid manufacturing adhesive comprising a non-water mixture and residual moisture, the non-water mixture comprising silk fibroin and a chaotropic salt, wherein:
the silk fibroin is present in the non-water mixture in an amount by weight of between 5% and 95% and the chaotropic salt is present in the non-water mixture in an amount by weight of between 5% and 95% of the non-water mixture; and
the chaotropic salt and the silk fibroin are present in a weight ratio of chaotropic salt to silk fibroin of between 15:1 and 1:20.
34. A solid shoe manufacturing adhesive made by dehydrating a silk fibroin solution comprising a chaotropic salt concentration of between 5 mg/mL and 100 mg/mL, the solid shoe manufacturing adhesive comprising a non-water mixture and residual moisture, the non-water mixture comprising the silk fibroin and the chaotropic salt, the dehydrating inhibiting transitions to beta sheet secondary structure and providing one or more of the following properties:
   i) a predetermined viscosity of between 100 cps and 500,000 cps upon addition of a predetermined viscosity amount of water at a predetermined viscosity temperature; or
   ii) a predetermined adhesive strength of at least 0.1 N/mm between two predetermined surfaces upon addition of a predetermined adhesive strength amount of water at a predetermined adhesive strength temperature and subsequent contact with the two predetermined surfaces under pressure,
wherein the solid shoe manufacturing adhesive is rehydrated in less than 5 minutes, less than 4 minutes, less than 3 minutes, less than 2 minutes, or less than 1 minute under rehydrating conditions.
35. A solid textile manufacturing adhesive made by dehydrating a silk fibroin solution comprising a chaotropic salt concentration of between 5 mg/mL and 100 mg/mL, the solid textile manufacturing adhesive comprising a non-water mixture and residual moisture, the non-water mixture comprising the silk fibroin and the chaotropic salt, the dehydrating inhibiting transitions to beta sheet secondary structure and providing one or more of the following properties:
   i) a predetermined viscosity of between 100 cps and 500,000 cps upon addition of a predetermined viscosity amount of water at a predetermined viscosity temperature; or
   ii) a predetermined adhesive strength of at least 0.1 N/mm between two predetermined surfaces upon addition of a predetermined adhesive strength amount of water at a predetermined adhesive strength temperature and subsequent contact with the two predetermined surfaces under pressure,
wherein the solid textile manufacturing adhesive is rehydrated in less than 5 minutes, less than 4 minutes, less than 3 minutes, less than 2 minutes, or less than 1 minute under rehydrating conditions.
36. A solid manufacturing adhesive made by dehydrating a silk fibroin solution having dissolved therein chaotropic salts in amounts of between 5 mg/mL and 100 mg/mL the solid manufacturing adhesive comprising a non-water mixture and residual moisture, the non-water mixture comprising the silk fibroin and the chaotropic salt, the dehydrating inhibiting transitions to beta sheet secondary structure and providing one or more of the following properties:
   i) a predetermined viscosity of between 100 cps and 500,000 cps upon addition of a predetermined viscosity amount of water at a predetermined viscosity temperature; or
   ii) a predetermined adhesive strength of at least 0.1 N/mm between two predetermined surfaces upon addition of a predetermined adhesive strength amount of water at a predetermined adhesive strength temperature and subsequent contact with the two predetermined surfaces under pressure,
wherein the solid manufacturing adhesive is rehydrated in less than 5 minutes, less than 4 minutes, less than 3 minutes, less than 2 minutes, or less than 1 minute under rehydrating conditions.
37. The adhesive of any one of clauses 34 to the immediately preceding clause, wherein the predetermined viscosity is between 100 cps and 250,000 cps.
38. The adhesive of any one of clauses 34 to the immediately preceding clause, wherein the predetermined viscosity is between 1000 cps and 100,000 cps.
39. The adhesive of any one of clauses 34 to the immediately preceding clause, wherein the predetermined viscosity amount of water is between 10% and 100% of a mass of the solid shoe manufacturing adhesive.
40. The adhesive of clause 39, wherein the predetermined viscosity amount of water is between 10% and 50% of the mass of the solid shoe manufacturing adhesive.
41. The adhesive of clause 39, wherein the predetermined viscosity amount of water is between 50% and 100% of the mass of the solid shoe manufacturing adhesive.
42. The adhesive of clause 39, wherein the predetermined viscosity amount of water is between 10% and 25% of the mass of the solid shoe manufacturing adhesive.
43. The adhesive of clause 39, wherein the predetermined viscosity amount of water is between 25% and 75% of the mass of the solid shoe manufacturing adhesive.
44. The adhesive of clause 39, wherein the predetermined viscosity amount of water is between 40% and 65% of the mass of the solid shoe manufacturing adhesive.
45. The adhesive of clause 39, wherein the predetermined viscosity amount of water is between 60% and 95% of the mass of the solid shoe manufacturing adhesive.
46. The adhesive of any one of clauses 34 to the immediately preceding clause, wherein the predetermined adhesive strength amount of water is between 10% and 100% of a mass of the solid shoe manufacturing adhesive.
47. The adhesive of clause 46, wherein the predetermined adhesive strength amount of water is between 10% and 50% of the mass of the solid shoe manufacturing adhesive.
48. The adhesive of clause 46, wherein the predetermined adhesive strength amount of water is between 50% and 100% of the mass of the solid shoe manufacturing adhesive.
49. The adhesive of clause 46, wherein the predetermined adhesive strength amount of water is between 10% and 25% of the mass of the solid shoe manufacturing adhesive.
50. The adhesive of clause 46, wherein the predetermined adhesive strength amount of water is between 25% and 75% of the mass of the solid shoe manufacturing adhesive.
51. The adhesive of clause 46, wherein the predetermined adhesive strength amount of water is between 40% and 65% of the mass of the solid shoe manufacturing adhesive.
52. The adhesive of clause 46, wherein the predetermined adhesive strength amount of water is between 60% and 95% of the mass of the solid shoe manufacturing adhesive.
53. The adhesive of any one of clauses 34 to the immediately preceding clause, wherein the predetermined viscosity temperature is between 20° C. and 150° C.
54. The adhesive of clause 53, wherein the predetermined viscosity temperature is between 20° C. and 50° C.
55. The adhesive of clause 53, wherein the predetermined viscosity temperature is between 50° C. and 150° C.
56. The adhesive of clause 53, wherein the predetermined viscosity temperature is between 25° C. and 90° C.
57. The adhesive of clause 53, wherein the predetermined viscosity temperature is between 60° C. and 120° C.
58. The adhesive of clause 53, wherein the predetermined viscosity temperature is between 30° C. and 75° C.
59. The adhesive of clause 53, wherein the predetermined viscosity temperature is between 45° C. and 100° C.
60. The adhesive of any one of clauses 34 to the immediately preceding clause, wherein the predetermined adhesive strength temperature is between 20° C. and 150° C.
61. The adhesive of clause 60, wherein the predetermined adhesive strength temperature is between 50° C. and 150° C.
62. The adhesive of clause 60, wherein the predetermined adhesive strength temperature is between 25° C. and 90° C.
63. The adhesive of clause 60, wherein the predetermined adhesive strength temperature is between 60° C. and 120° C.
64. The adhesive of clause 60, wherein the predetermined adhesive strength temperature is between 30° C. and 75° C.
65. The adhesive of clause 60, wherein the predetermined adhesive strength temperature is between 45° C. and 100° C.
66. The adhesive of clause 60, wherein the predetermined adhesive strength temperature is between 20° C. and 150° C.
67. The method or adhesive of any one of clauses 1 to the immediately preceding clause, wherein the silk fibroin has a molecular weight distribution including a weight average molecular weight of between 25 kDa and 150 kDa, between 30 kDa and 100 kDa, or between 35 kDa and 75 kDa.
68. The method or adhesive of any one of clauses 1 to the immediately preceding clause, wherein the non-water mixture comprises a plasticizer.
69. The method or adhesive of clause 68, wherein the plasticizer is glycerol.
70. The method or adhesive of clause 68, wherein the plasticizer is present in the non-water mixture in an amount by weight of between 1% and 50%, between 1% and 25%, or between 1% and 5% of the non-water mixture.
71. The method or adhesive of any one of clauses 1 to the immediately preceding clause, wherein the solid shoe manufacturing adhesive is not adhesive to human skin, is not sticky when handled by human hands, or a combination thereof.
72. The method or adhesive of any one of clauses 1 to the immediately preceding clause, wherein the silk fibroin comprises silk fibroin fragments cross-linked to other silk fibroin fragments.
73. The method or adhesive of any one of clauses 1 to the immediately preceding clause, wherein the silk fibroin is a covalently modified silk fibroin.
74. The method or adhesive of clause 73, wherein the covalently modified silk fibroin is a dopamine-modified silk fibroin.
75. The method or adhesive of clause 73, wherein the covalently modified silk fibroin is an acrylate-modified silk fibroin.
76. The method or adhesive of clause 73, wherein the covalently modified silk fibroin is a gallic acid-modified silk fibroin.
77. The method or adhesive of clause 73, wherein the covalently modified silk fibroin is a phoroglucinol-modified silk fibroin.
78. The method or adhesive of clause 73, wherein the covalently modified silk fibroin is a carbamate-modified silk fibroin.
79. The method or adhesive of any one of clauses 1 to the immediately preceding clause, wherein the silk fibroin is cross-linked to a functional moiety.
80. The method or adhesive of any one of clauses 1 to the immediately preceding clause, wherein the non-water mixture comprises an additive.
81. The method or adhesive of clause 80, wherein the additive is bisphenol A.
82. The method or adhesive of clause 80, wherein the additive is an enzyme.
83. The method or adhesive of clause 82, wherein the enzyme is a horseradish peroxidase.
84. The method or adhesive of clause 82, wherein the enzyme is a tyrosinase.
85. The method or adhesive of clause 82, wherein the enzyme is a lactase.
86. The method or adhesive of clause 80, wherein the additive is acrylic acid.
87. The method or adhesive of clause 80, wherein the additive is or comprises dopamine.
88. The method or adhesive of any one of clauses 1 to 87, wherein the chaotropic salt is present in an amount by weight of the non-water mixture of between 5% and 25%.
89. The method or adhesive of any one of clauses 1 to 87, wherein the chaotropic salt is present in an amount by weight of the non-water mixture of between 15% and 45%.
90. The method or adhesive of any one of clauses 1 to 87, wherein the chaotropic salt is present in an amount by weight of the non-water mixture of between 25% and 50%.
91. The method or adhesive of any one of clauses 1 to 87, wherein the chaotropic salt is present in an amount by weight of the non-water mixture of between 50% and 75%.
92. The method or adhesive of any one of clauses 1 to 87, wherein the chaotropic salt is present in an amount by weight of the non-water mixture of between 60% and 90%.
93. The method or adhesive of any one of clauses 1 to 87, wherein the chaotropic salt is present in an amount by weight of the non-water mixture of between 40% and 65%.
94. The method or adhesive of any one of clauses 1 to 87, wherein the chaotropic salt is present in an amount by weight of the non-water mixture of between 25% and 80%.
95. The method or adhesive of any one of clauses 1 to 94, wherein the silk fibroin is present in an amount by weight of the non-water mixture of between 5% and 25%.
96. The method or adhesive of any one of clauses 1 to 94, wherein the silk fibroin is present in an amount by weight of the non-water mixture of between 15% and 45%.
97. The method or adhesive of any one of clauses 1 to 94, wherein the silk fibroin is present in an amount by weight of the non-water mixture of between 25% and 50%.
98. The method or adhesive of any one of clauses 1 to 94, wherein the silk fibroin is present in an amount by weight of the non-water mixture of between 50% and 75%.
99. The method or adhesive of any one of clauses 1 to 94, wherein the silk fibroin is present in an amount by weight of the non-water mixture of between 60% and 90%.
100. The method or adhesive of any one of clauses 1 to 94, wherein the silk fibroin is present in an amount by weight of the non-water mixture of between 40% and 65%.
101. The method or adhesive of any one of clauses 1 to 94, wherein the silk fibroin is present in an amount by weight of the non-water mixture of between 25% and 80%.
102. The method or adhesive of any one of clauses 1 to 101, wherein the weight ratio of chaotropic salt to silk fibroin is between 2:1 and 1:10.
103. The method or adhesive of any one of clauses 1 to 101, wherein the weight ratio of chaotropic salt to silk fibroin is between 5:1 and 1:10.
104. The method or adhesive of any one of clauses 1 to 101, wherein the weight ratio of chaotropic salt to silk fibroin is between 2:1 and 1:5.
105. The method or adhesive of any one of clauses 1 to 101, wherein the weight ratio of chaotropic salt to silk fibroin is between 2:1 and 1:2.
106. The method or adhesive of any one of clauses 1 to 101, wherein the weight ratio of chaotropic salt to silk fibroin is between 1:1 and 1:5.
107. The method or adhesive of any one of clauses 1 to 101, wherein the weight ratio of chaotropic salt to silk fibroin is between 2:1 and 1:1.
108. The method or adhesive of any one of clauses 1 to 101, wherein the weight ratio of chaotropic salt to silk fibroin is between 1:1 and 1:2.

1.-2. (canceled)

3. A manufacturing method comprising adhering a low-energy surface to a second surface, wherein the low-energy surface has a surface energy less than 100 mJ/m², the manufacturing method comprising:
a) adding a predetermined rehydration amount of water to a solid manufacturing adhesive at a predetermined rehydration temperature to produce a rehydrated adhesive, the solid manufacturing adhesive comprising a non-water mixture and residual moisture, the non-water mixture comprising silk fibroin and a chaotropic salt, wherein the chaotropic salt is present in an amount by weight of the non-water mixture of between 5% and 95%, wherein the silk fibroin is present in an amount by weight of the non-water mixture of between 5% and 95%, wherein the chaotropic salt and the silk fibroin are present in the non-water mixture in a weight ratio of chaotropic salt to silk fibroin of between 20:1 and 1:15; and
b) contacting opposing faces of a thin film of the rehydrated adhesive with the low-energy surface and the second surface under pressure to adhere the low-energy surface to the second surface.

4. The method of claim 3, wherein:
the rehydrated adhesive has a viscosity of between 100 cps and 500,000 cps.

5.-6. (canceled)

7. A solid manufacturing adhesive comprising a non-water mixture and residual moisture, the non-water mixture comprising silk fibroin and a chaotropic salt, wherein:
the silk fibroin is present in the non-water mixture in an amount by weight of between 5% and 95% and the chaotropic salt is present in the non-water mixture in an amount by weight of between 5% and 95% of the non-water mixture; and
the chaotropic salt and the silk fibroin are present in a weight ratio of chaotropic salt to silk fibroin of between 15:1 and 1:20.

8.-9. (canceled)

10. A solid manufacturing adhesive made by dehydrating a silk fibroin solution having dissolved therein chaotropic salts in amounts of between 5 mg/mL and 100 mg/mL the solid manufacturing adhesive comprising a non-water mixture and residual moisture, the non-water mixture comprising the silk fibroin and the chaotropic salt, the dehydrating inhibiting transitions to beta sheet secondary structure and providing one or more of the following properties:
i) a predetermined viscosity of between 100 cps and 500,000 cps upon addition of a predetermined viscosity amount of water at a predetermined viscosity temperature; or
ii) a predetermined adhesive strength of at least 0.1 N/mm between two predetermined surfaces upon addition of a predetermined adhesive strength amount of water at a predetermined adhesive strength temperature and subsequent contact with the two predetermined surfaces under pressure,
wherein the solid manufacturing adhesive is rehydrated in less than 5 minutes under rehydrating conditions.

11. (canceled)

12. The method of claim 3, wherein the non-water mixture comprises a plasticizer.

13. The method of claim 3, wherein the solid manufacturing adhesive is not adhesive to human skin, is not sticky when handled by human hands, or a combination thereof.

14. The method of claim 3, wherein the silk fibroin comprises silk fibroin fragments cross-linked to other silk fibroin fragments.

15. The method of claim 3, wherein the silk fibroin is a covalently modified silk fibroin.

16. The method of claim 3, wherein the silk fibroin is cross-linked to a functional moiety.

17. The method of claim 3, wherein the non-water mixture comprises an additive, additive

18. The method of claim 3, wherein:
the chaotropic salt is present in an amount by weight of the non-water mixture of between 5% and 25%, between 15% and 45%, between 25% and 50%, between 50% and 75%, between 60% and 90%, between 40% and 65%, or between 25% and 80%; and/or
the silk fibroin is present in an amount by weight of the non-water mixture of between 5% and 25%, between 15% and 45%, between 25% and 50%, between 50% and 75%, between 60% and 90%, between 40% and 65%, or between 25% and 80%; and/or
the weight ratio of chaotropic salt to silk fibroin is between 2:1 and 1:10, between 5:1 and 1:10, between 2:1 and 1:5, between 2:1 and 1:2, between 1:1 and 1:5, between 2:1 and 1:1, or between 1:1 and 1:2.

19. The method of claim 3, wherein a first shoe part comprises the low-energy surface and a second shoe part comprises the second surface.

20. The method of claim 3, wherein the adding of step a) produces a rehydrated adhesive in less than 5 minutes.

21. The method of claim 3, wherein the contacting of step b) is performed at elevated temperature.

22. The method of claim 3, wherein the low-energy surface is a polyurethane surface, a nylon surface, a polyester surface, a polycarbonate surface, an acrylic surface, or a combination thereof.

23. The method of claim 22, wherein the second surface is a leather surface, an alternative leather surface, a leather-like surface, or a combination thereof.

24. The method of claim 3, wherein the solid manufacturing adhesive comprises dopamine and/or the silk fibroin is dopamine-modified silk fibroin.

25. The method of claim 3, wherein the predetermined rehydration amount of water is between 10% and 100% of a mass of the solid shoe manufacturing adhesive.

26. The method of claim 3, wherein the low-energy surface is a polyvinyl acrylate surface, an acetal surface, an ethylene-vinyl acetate surface, a polyethylene surface, a polypropylene surface, a polyvinyl chloride surface, a polytetrafluoroethylene surface, or a combination thereof.

27. The method of claim 3, wherein the low-energy surface and the second surface are adhered with a peel strength of at least 0.2 N/mm.
